(19) United States
(12) Patent Application Publication
(10) Pub. No.: US 2022/0357210 A1
(43) Pub. Date: Nov. 10, 2022

(54) Temperature Sensor Assembly And Method Of Making Temperature Sensor Assembly

(71) Applicant: Therm-O-Disc Incorporated, Mansfield, OH (US)

(72) Inventor: Adrian MOLDOVAN, Cluj Napoca (RO)

(21) Appl. No.: 17/561,103

(22) Filed: Dec. 23, 2021

Related U.S. Application Data
(60) Provisional application No. 63/185,028, filed on May 6, 2021.

(51) Int. Cl. G01K 1/16; G01K 7/16; G01K 1/14

(52) U.S. Cl. CPC G01K 1/16; G01K 7/16; G01K 1/14

(57) ABSTRACT

A temperature sensor is provided including a inner body (e.g., a connector body), an outer body (e.g., a cup), a thermally-conductive plate, a fastener clip, and a temperature sensor element. The cup includes a bottom wall with an opening with a portion of the plate positioned within the opening. The temperature sensor element is attached to the connector body and the connector body is attached to the cup with the temperature sensor element being positioned within the cup and in close proximity to the plate. A fastener clip is attached to the connector body.

### CROSS-REFERENCE TO RELATED APPLICATIONS

This application claims the benefit and priority of U.S. Provisional Application No. 63/185,028, filed May 6, 2021. The entire disclosure of the above application is incorporated herein by reference.

### FIELD

The present disclosure relates to a temperature sensor assembly and a method of making a temperature sensor assembly.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Temperature sensor assemblies may be mounted on a tube, pipe, or like structure conveying a fluid to determine the temperature of the fluid. Current conventional temperature sensor assemblies for mounting on a tube may be limited by customer-specific design parameters that complicate the manufacture and assembly of such temperature sensor assemblies. Accordingly, conventional temperature sensor assemblies and assembly methods are subject to improvement.

### SUMMARY

In one exemplary aspect of the disclosure, a temperature sensor assembly is provided that may include an inner body (e.g., a connector body), and outer body (e.g., a cup), a thermally conductive plate, a fastener clip, and a temperature sensor element. The cup may have a bottom wall with a centrally disposed opening or hole. The plate may be disposed within the cup so that a portion of the plate is positioned within the hole in the bottom wall of the cup. The temperature sensor element is attached to the connector body. The connector body may be attached to the cup so that the temperature sensor element is disposed within the cup and in close proximity to or abutting the plate when the connector body is attached to the cup. The clip may be attached to the connector body so that the temperature sensor assembly may be clipped, mounted or otherwise attached to engage an apparatus (or its component(s)) in a manner facilitating direct contact between the cup (and, particularly, the thermally conductive plate) and the apparatus (or its component(s)). In this manner, the temperature sensor assembly is operable to sense a temperature of the apparatus or component(s) and/or of an operating fluid associated with the apparatus.

In another example, a method of assembling a temperature sensor assembly is provided including selecting a connector body from among a plurality of different connector bodies and selecting a temperature sensor element from among a plurality of different temperature sensor elements. The method may further include attaching the temperature sensor element to the connector body, attaching the connector body with attached temperature sensor element to a cup assembly, selecting a clip from among a plurality of different clips, and attaching the clip to the connector body.

In still another aspect of the disclosure, a temperature sensor assembly is described to include an inner body having a planar member and a lower projection extending from a bottom side of the planar member and the planar member has an upper projection extending from a top side of the planar member. A plurality of electrically conductive leads extend through the inner body and are generally parallel with an axis of the temperature sensor assembly. A temperature sensor element has a temperature-sensitive resistor electrically connected to the plurality of electrically conductive leads. An outer body of the temperature sensor assembly has a bottom wall having an centrally disposed opening. A thermally-conductive plate is located within the outer body and a portion of the thermally-conductive plate is positioned in the opening of the bottom wall of the outer body. The inner body is received in the outer body and the temperature sensor element is disposed near to the thermally-conductive plate. A fastener clip is attached to the upper projection of the inner body and extends beneath the bottom wall of the outer body.

In another aspect of the disclosure, the lower projection of the inner body of the temperature sensor assembly of has two opposing long edges, two opposing short edges and two opposing walls. Each of the two opposing walls extends from a proximal end near a respective one of the two opposing long edges of the lower projection to a distal end that abuts the thermally-conductive plate.

In another aspect of the disclosure, the thermally-conductive plate includes a center section and two side sections. Each of the two side sections has a first portion that extends from the center section at an angle relative to the center section and a second portion that extends from the first portion in a direction generally parallel to the center section. The center section of the thermally-conductive plate is disposed within the opening in the bottom wall of the outer body and the second portions of the two side sections engage an inner side of the bottom wall of the outer body. The distal ends of the two opposing walls of the lower projection abut a respective side section of the thermally-conductive plate. The temperature sensor element is positioned adjacent to the center section of the thermally-conductive plate and within the outer body.

In still another aspect of the disclosure, the planar member of the inner body of the temperature sensor assembly of includes two opposing long edges and two opposing short edges. The two opposing short edges are, respectively, offset from the two opposing short edges of the planar member along the axis and the two opposing walls are, respectively, offset from the two opposing long edges toward the axis. Each of the two opposing walls includes a hook-like projection extending from the wall in a direction away from the axis. The bottom wall of the outer body has two opposing long edges and two opposing short edges and two opposing long sidewalls and two opposing short side walls. Each of the two opposing long side walls extends, respectfully, from an opposing long edge of the bottom wall and each of the two opposing short side walls extends from a respective opposing short edge of the bottom wall. Each of the two opposing long side walls includes a notch and each hook-like projection engage a respective notch to attach the inner body to the outer body.

In yet another aspect of the disclosure, a fastener clip is attached to the inner body and includes an upper engagement portion that extends generally parallel to the top side of the inner body and having an opening, and the upper projection of the inner body engages the opening in the upper engagement portion of the fastener clip to attach the fastener clip to the inner body.

In another aspect of the disclosure, the temperature sensor assembly includes an elastomeric seal extending around a perimeter of the lower projection of the inner body.

Further aspects and areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of an example temperature sensor housing installed on a tube/pipe;

FIG. 2 is an exploded view of the example temperature sensor;

FIG. 3A is a top perspective view of an example connector body;

FIG. 3B is a bottom perspective view of the example connector body shown in FIG. 3A;

FIG. 4 is a side view of the example connector body with attached temperature sensor;

FIG. 5A is a top perspective view of an example cup;

FIG. 5B is a bottom perspective view of the example cup shown in FIG. 5A;

FIG. 6 is a perspective view of an example housing with a temperature sensor;

FIG. 7A is a perspective view of an example plate;

FIG. 7B is a front view of the example plate shown in FIG. 7A;

FIG. 8 illustrates an example installation of a temperature sensor;

FIG. 9 is a perspective view of an example clip;

FIG. 10 is an exploded view of another example housing;

FIG. 11A is a perspective view of another example temperature sensor assembly;

FIG. 11B is a side view of the example temperature sensor assembly shown in FIG. 11A;

FIG. 12 is a perspective view of another example connector body;

FIG. 13 is a side view of yet another example connector body;

FIG. 14 is a cross-sectional view of yet another example housing including the example connector body shown in FIG. 13; and

FIG. 15 is a flowchart showing example processes for assembling a temperature sensor assembly.

In the drawings, reference numbers may be reused to identify similar and/or identical elements.

### DETAILED DESCRIPTION

Conventional temperature sensor assemblies for mounting on pipes, tubes, and like structures can be used to host a variety of temperature sensor elements within a housing of the assembly. However, such conventional temperature sensor assemblies may be complicated to manufacture. More specifically, conventional temperature sensor assemblies may be based on customer-specific designs that require more complicated assembly procedures. For example, conventional temperature sensor assemblies may require assembly by hand using an epoxy adhesive to join the parts of the sensor assembly together. Such conventional temperature sensor assemblies may require increased time, labor, and cost to assemble. In addition, the epoxy adhesive used in the assembly of conventional temperature sensor assemblies may add to the overall mass of the finished sensor assembly.

The improved temperature sensor assembly of the present disclosure can realize improvements over the conventional assemblies by providing an improved structure than can be produced and assembled by automated manufacturing processes without the use of adhesives such as epoxy. The improved temperature sensor assembly of the present disclosure can also use a variety of modular interchangeable component parts. In turn, the improved temperature sensor assembly of the present disclosure can realize cost savings and faster manufacturing times by using parts that are simple to produce and assemble without the use of epoxy adhesives.

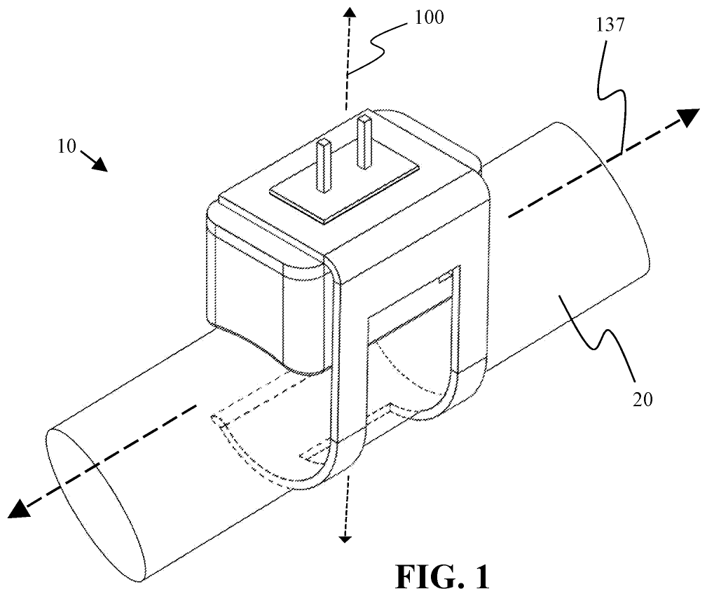

With reference to FIG. 1, a perspective view of an example temperature sensor assembly 10 mounted on a pipe 20 is illustrated. The temperature sensor assembly 10 may be attached to the pipe 20 so that a temperature sensor element within the housing of the temperature sensor assembly 10 can directly measure the temperature of the pipe 20 itself and thereby indirectly measure a temperature of a fluid flowing through the pipe 20. That is, the output from the temperature sensor element disposed within the temperature sensor assembly may be used to determine the temperature of a fluid in the pipe 20. For reference, a vertical or first axis 100 and a longitudinal or second axis 137 are shown in FIG. 1.

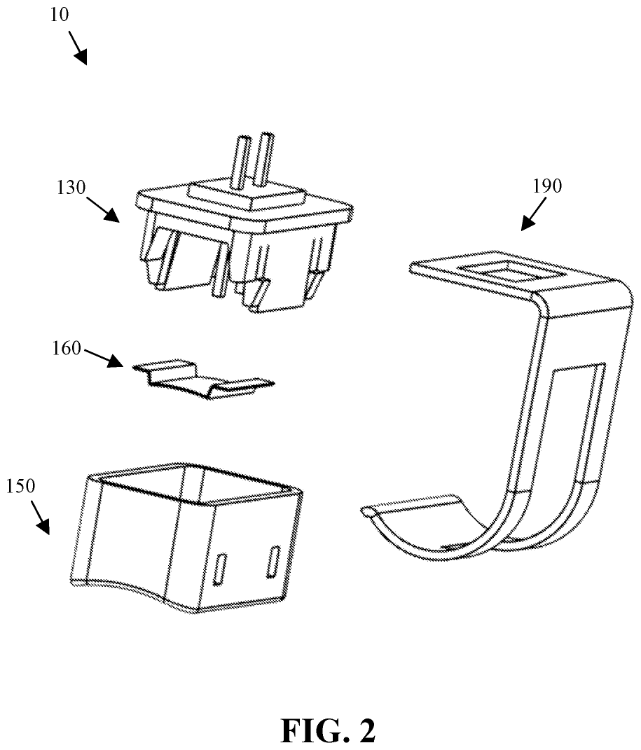

With reference now to FIG. 2, an exploded view of the temperature sensor assembly 10 is illustrated. The temperature sensor assembly 10 includes an inner body, e.g., a connector body 130, an outer body, e.g., a cup 150, a thermally-conductive plate 160, and a fastener clip 190.

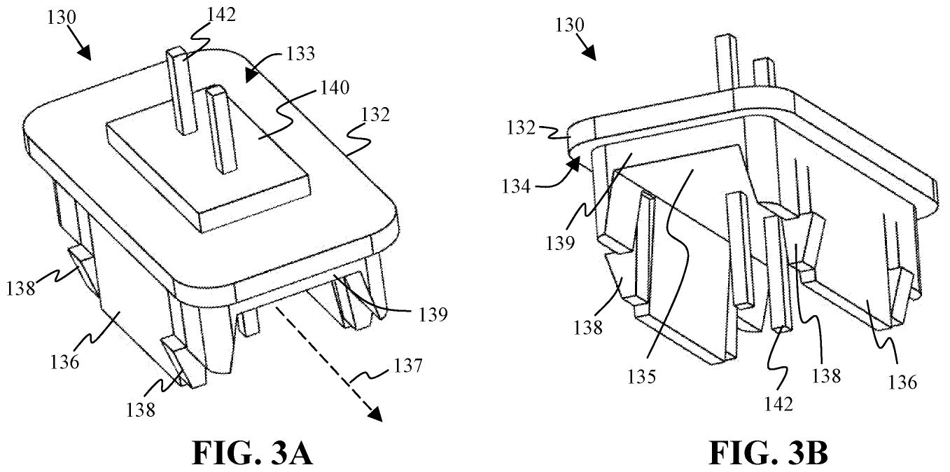

Top and bottom perspective views of an example connector body 130 are illustrated respectively in FIGS. 3A and 3B. The connector body 130 includes a planar member 132. The planar member 132 may be shaped as a cuboid, such as a rectangular prism with rounded corners. The planar member 132 may act as a lid for the housing that is formed when the connector body 130 is attached to the cup 150. The planar member 132 has a top side 133 shown in FIG. 3A and a bottom side 134 shown in FIG. 3B.

The connector body 130 also includes a lower projection 135 extending from the bottom side 134 of the planar member 132. Like the planar member 132, the lower projection 135 is planar in shape, but has two side walls 136 extending along the long edges of the bottom projection 135. That is, a base of the lower projection 135 may be cuboid in shape, for example, a rectangular prism, with side walls 136 extending from the long edges of the cuboid-shaped base. The two side walls 136 are perpendicular to the planar member 132 and parallel to each other. The long edges of the planar member 132, lower projection 135, and other parts may refer to the edges extending longitudinally or in the long direction, i.e., in the direction of, and parallel to, the longitudinal or second axis 137.

Each of the two side walls 136 may include one or more snap connections 138 projecting outward from the wall 136. The snap connections 138 can be generally hook-like or Christmas tree-shaped projections or protrusions that extend away from the wall 136 and are configured to engage corresponding notches on the cup 150 to secure the connector body 130 to the cup 150. The snap connections 138 are elastic and may deform when stressed by other structural elements acting on the snap connections 138. However, the snap connections 138 can return to original positions once the stresses acting on the snap connections 138 are removed. For example, when the lower projection 135 on the bottom side 134 of the planar member 132 is inserted into the cup 150, the snap connections 138 project outward and away from the side walls 136 of the connector body 130 so that the snap connections 138 may contact the walls of the cup 150. As such, the walls of the cup 150 may press on the snap connections 138 to deform the snap connections 138 toward the longitudinal axis 137. When the snap connections 138 engage notches in the walls of the cup 150, the hook-like projections engage the notches and relieve the stress causing the deformation of the snap connections 138 to fixedly attach the connector body 130 to the cup without using adhesive.

The lower projection 135 of the connector body 130 also has two short side surfaces 139 disposed on the short edges of the lower projection 135, i.e., in a direction perpendicular to the longitudinal axis. The short side surfaces 139 of the lower projection are perpendicular to the side walls 136 and extend between the side walls 136. As shown in FIGS. 3A and 3B, the side walls 136 and short side surfaces 139 of the lower projection 135 are offset from the edges of the planar member 132. In other words, the side walls 136 and the short side surfaces of the lower projection 135 are spaced apart from the edges of the planar member 132 so that there is a perimeter of a fixed distance on the bottom side 134 of the planar member 132 around the bottom projection 135. The thickness or width of the perimeter may correspond to the thickness of the walls of the cup 150. The offset distance allows the bottom projection 135 of the connector body 130 to fit within the cup 150 when the connector body 130 is engaged to the cup 150.

The top side 133 of the planar member 132 may include an upper projection 140. The upper projection 140 is also planar in shape and extends from the top side 133 of the planar member 132. The projection 140 may be cuboid shaped, such as a rectangular prism.

The connector body 130 also includes two or more conductive leads 142 that can be used to connect the temperature sensor assembly 10 to an external connector (not shown). The two or more conductive leads 142 extend through the planar member 132, the lower projection 135, and the upper projection 140. The two or more conductive leads 142 may be of an electrically conductive material such as copper or aluminum.

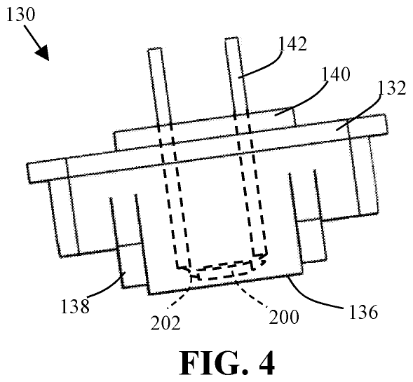

With reference to FIG. 4, an example connector body 130 with an attached temperature sensor element 200 is shown. The temperature sensor element 200 may be connected to the conductive leads 142. The temperature sensor element 200 may have electrical leads 202 that can connect to the conductive leads 142 so that the temperature sensor element 200 is in electrical connection with the conductive leads 142. The electrical leads 202 may be fixed to the conductive leads by soldering, reflow soldering, wire wrapping, or a like joining process.

While the example temperature sensor element 200 shown in FIG. 4 is illustrated with two electrical leads 202 connected to the two conductive leads 142, the connector body 130 may include additional conductive leads 142 for temperature sensor elements 200 having more than two electrical leads 202. For example, if the temperature sensor element 200 has three electrical leads, the connector body 130 may include three conductive leads 142 to correspond to the number of electrical leads on the temperature sensor element 200. In another example, the number and arrangement of conductive leads 142 in the connector body 130 may be standardized based on standardized external connectors that may be used to connect to the connector portion 140. For example, the conductive leads 142 may be arranged as standardized male pin headers so that the spacing between each of the conductive leads 142 is standardized at 2.54 mm (0.1 in) to accommodate a standardized female socket header as an external connector (not shown).

The conductive leads 142 can be used to a measure a change in resistance across temperature sensor element 200. For example, the temperature sensor element 200 may be a thermistor such as a thermistor having a negative temperature coefficient (NTC thermistor) or a thermistor having a positive temperature coefficient (PTC thermistor). Alternatively, the temperature sensor element 200 may be a resistance temperature detector (RTD). An example of an RTD temperature sensor element 200 is a platinum resistance thermometer (PRT). Both thermistor- and RTD-type temperature sensor elements 200 measure temperature based on a resistance versus temperature relationship. More specifically, as the temperature of a fluid within the pipe 20 changes, or alternatively, as the temperature of the pipe 20 changes as a result of a temperature of a fluid within the pipe 20 changing, the resistance of the temperature sensor 200 varies. The resistance value across the temperature sensor, for example, measured across the conductive leads 142, can be used as the basis for determining the temperature of the pipe 20 or the fluid within the pipe 20. For example, a microcontroller may be attached to the external connector that attaches to the conductive leads 142 of a temperature sensor assembly 10 with the microcontroller configured to correlate a change in resistance measured across the temperature sensor element 200 to determine a temperature of the pipe 20 or fluid within the pipe 20.

The upper projection 140 may be used to engage a portion of the clip 190 to connect the clip 190 to the temperature sensor assembly 10. The length and width dimensions of the upper projection 140 may be standardized so as to match a corresponding standardized dimension on the clip 190. In this manner, the clip 190 as well as other clips may be attached to the upper projection 140 of the connector body 130.

With the exceptions of the conductive leads 142, the remainder of the connector body 130 may be made of a thermoplastic or like polymer/plastic material. For example, the connector body 130 may be formed by injection molding or a like plastic forming process. As an example only, the connector body 130 may be formed by a combination of injection molding processes. For example, the conductive leads 142 may be positioned in a mold cavity for forming the connector body 130 where the remaining plastic portions of the connector body 130 are formed by injecting a thermoplastic into the mold cavity and around the conductive lead inserts to form the connector body 130 as part of an insert molding process. The connector body 130 may then be finished by attaching the temperature sensor element 200 via electrical leads 202 to the conductive leads 142 of the connector body 130, for example, by soldering. The finished connector body 130 including an attached temperature sensor element 200 may be used as a subassembly as part of the assembly process for the temperature sensor assembly.

Depending on the materials used for the planar member 132, the lower projection 135, and the upper projection 140, other injection molding processes or combination of different injection molding processes may be used to manufacture the connector body 130. For example, while an insert molding process may mold the planar member 132 and the lower projection 135 around the conductive leads 142, the upper projection 140 may be added in a subsequent molding process, for example, by overmolding. The manufacture of the connector body 130 is not limited to injection molding processes. Other processes such as additive manufacturing (e.g., 3D printing) may be used to form the plastic and polymer portions of the connector body 130 around the conducive leads 142.

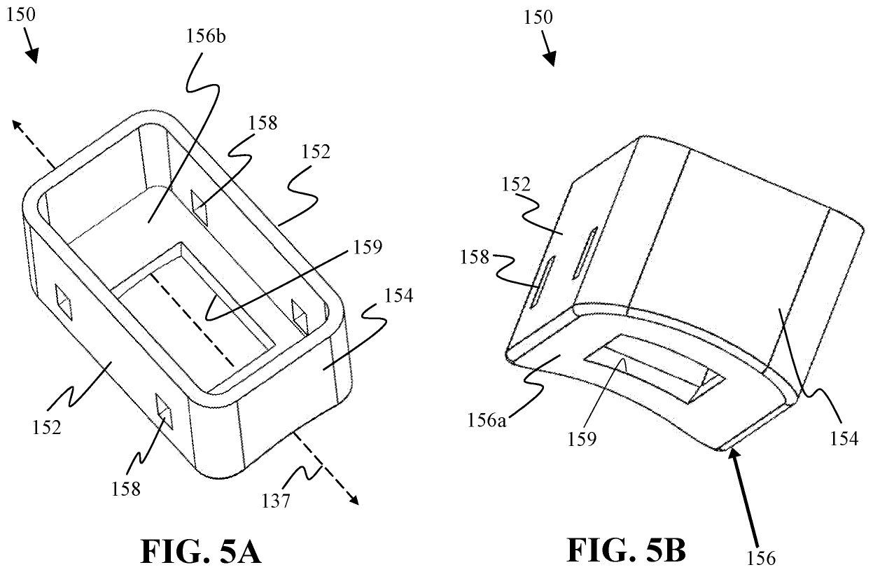

FIGS. 5A and 5B respectively illustrate a top perspective view of an example cup 150 and a bottom perspective view of the cup 150. The cup 150 has two pairs of side walls 152, 154. The side walls 152 are disposed on opposite sides of the cup 150 and extend along the long edges of the cup 150 so that the side walls 152 are parallel to one another. The side walls 154 are disposed on opposite sides of the cup 150 and extend along the short edges of the cup 150. The side walls 154 are parallel to each other and extend between the pair of side walls 152.

The cup 150 also includes a bottom wall 156 having an outer or exterior surface 156a and an inner or interior surface 156b. Portions of the exterior surface 156a of the bottom wall 156 contact the pipe 20 when the temperature sensor assembly 10 is attached to the pipe 20. The bottom wall 156 may be slightly curved so that the temperature sensor assembly 10 better interfaces with the cylindrical-shaped pipe 20 when the temperature sensor assembly 10 is attached to the pipe 20. In other words, the bottom wall 156 is not a completely flat, but has a slight curve about the longitudinal axis 137 so that the temperature sensor assembly 10 better conforms to the circular profile of the pipe 20.

The side walls 152 extend from the bottom wall 156 along the long edges of the bottom wall 156. The long edges of the bottom wall are the edges extending in the direction of the longitudinal axis 137. The side walls 154 extend from the bottom wall 156 along the short edges of the bottom wall 156. The side walls 152, 154 are disposed directly at the edges of the bottom wall 156. In this manner, when the connector body 130 is joined to the cup 150, the side walls 152, 154 surround and house the structural features disposed on the on the bottom side 134 of the planar member 132 and offset from the edges from the planar member 132.

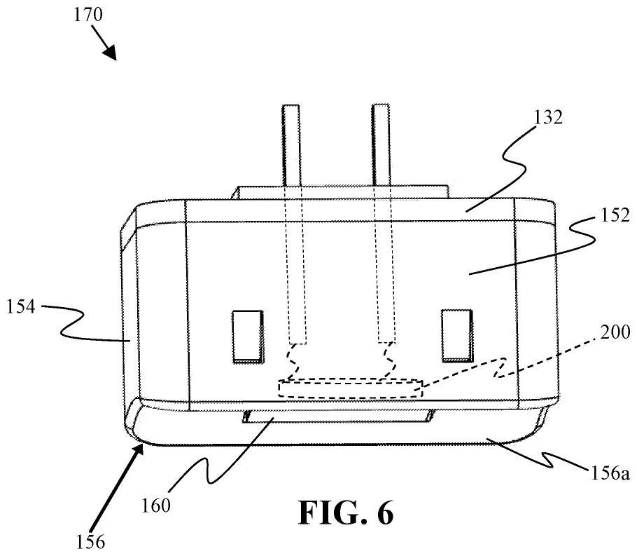

With reference now to FIG. 6, an example housing 170 of the temperature sensor assembly 10 is shown. The housing 170 refers to the structure of the temperature sensor assembly 10 that is formed by the combination of the connector body 130, the cup 150, and the plate 160. That is, the housing 170 describes the structure formed by assembling the connector body 130, the cup 150, and the plate 160 together as a unit. The structural features on the bottom side 134 of the planar member 132 are disposed within the volume of the housing 170. The volume of the housing 170 may refer to the voluminous space inside the housing that is bounded by the side walls 152, 154 and the bottom wall 156 of the cup 150, the plate 160, and the planar member 132 of the connector body 130. For example, when the connector body 130 is joined to the cup 150, the side walls 136 of the connector body 130 and a temperature sensor element 200 attached to the connector body 130 are disposed within the volume of the housing 170.

With reference again to FIGS. 5A and 5B, the side walls 152 along the long edges of the bottom wall 156 include notches 158 that correspond to the hook-like snap connections 138 on the side walls 136 of the connector body 130. When the side walls 136 of the connector body 130 are inserted into the cup 150, the snap connections 138 may contact the side walls 152 of the cup 150 and may be displaced or deformed inwardly toward the longitudinal axis 137. However, as each of the hook-like snap connections 138 align with a corresponding notch 158 on the side walls 152 of the cup 150, the stresses acting on the snap connections 138 are released, and the snap connections 138 “snap” into the notches to form a connection between the connector body 130 and the cup 150. That is, the deformed snap connections 138 return to original, non-deformation states, such that the hooks of the snap connections 138 engage the notches 158 of the side walls 152 to join the connector body 130 to the cup 150. In such manner, the connector body 130 can be joined to the cup 150 to form a housing 170 without the use of epoxy adhesive.

The dimensional tolerances for the snap connections 138 and the notches 158 may be refined such that the snap connections 138 closely engage the notches 158 so as to inhibit and/or prevent the ingress of dust, water, and other foreign matter into the inner volume of the housing 170. In other words, reducing the “play” between the snap connections 138 and the notches 158 may join the planar member 132 of the connector body 130 to the walls 152, 154 of the cup 150 to help limit or prevent water, dust or undesirable contaminants from entering the housing 170.

The bottom wall 156 includes an opening or hole 159. The hole 159 is disposed centrally within the bottom wall 156. The hole 159 allows a portion of the thermally conductive plate 160 to be exposed through the hole 159 so that the exposed portion of the plate 160 is in direct physical contact with the pipe 20 when the temperature sensor assembly 10 is mounted to the pipe 20.

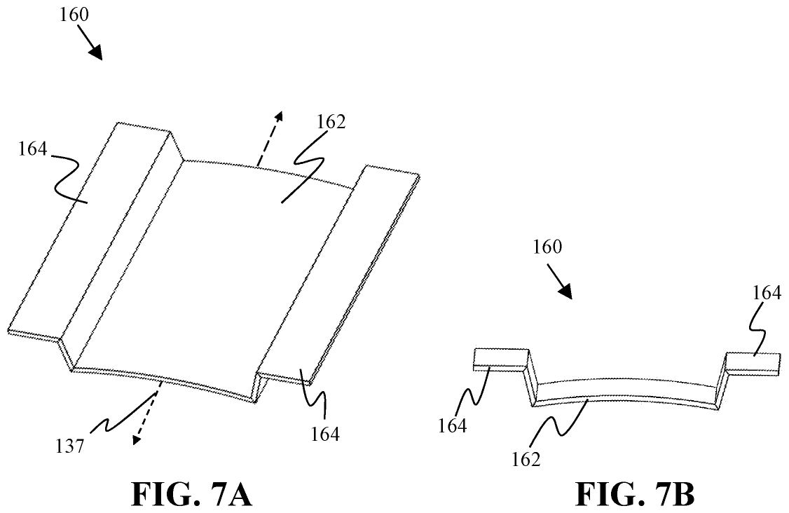

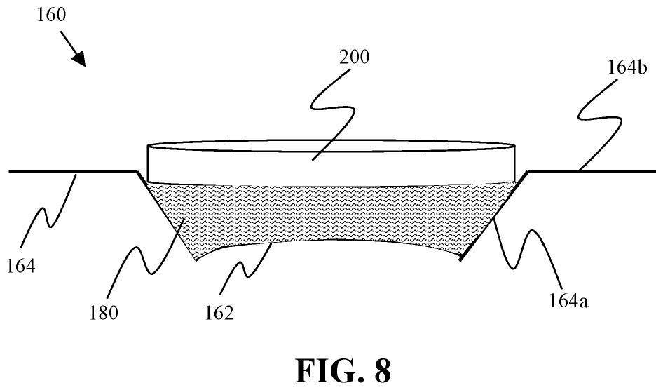

With reference now to FIGS. 7A and 7B, and example thermally conductive plate 160 is shown. The plate 160 includes a center section 162 and two wings or side sections 164 extending from opposite sides of the center section162 laterally relative to the longitudinal axis 137. The center section162 may be a generally planar-shaped member having a slight curvature to match the curvature of the bottom wall 156. The wings 164 may include a first portion 164a that extends from the center section 162 at an incline and a second portion 164b that extends generally horizontally (see, e.g., FIG. 8) from the first portion 164a in a direction away from the longitudinal axis 137. Each of the wings 164 includes a bend between the first portion 164a and the second portion 164b so the second portion 164b of the wing 164 extends laterally from the bend and substantially parallel to the center section162. The portions 164b of the wings 164 extending laterally from the bend are generally parallel to the interior surface 156b bottom 162 if the center section162 were flat without any curvature. Thus, substantially parallel is used here to account for the curvature in the center section162.

When forming the housing 170 shown in FIG. 6, the plate 160 is first inserted through the top of the cup 150 before the connector body 130 is joined to the cup 150.

The center section162 of the plate 160 fits into or nests within the hole 159 in the bottom wall 156 of the cup 150. The center section162 of the plate 160 is curved similar to the curve in the bottom wall 156 of the cup 150 so that the center section162 of the plate 160, like the bottom wall 156 of the cup 150, better contours to the rounded profile of the pipe 20. As shown in FIG. 7A, the center section162 of the plate 160 is curved about the longitudinal axis 137 to have a curved profile, as shown in FIG. 7B.

The plate 160 may be made of a material that readily conducts and transfers heat so that heat from the pipe 20 (or rather, heat from the fluid inside the pipe 20 that is conducted through the pipe 20 wall) may be transferred via the plate 160 to the temperature sensor element 200 within the housing 170. For example, the plate 160 may be of a metal such as copper. The plate 160 may be formed from a metal and sized and/or shaped by a metal working process such as stamping.

With reference to FIG. 8, an example mounting arrangement between the temperature sensor element 200 and the plate 160 is illustrated. The portion of the center section162 of the plate 160 that is disposed within the housing 170 and portions of the wings 164 may be coated with a thermal compound 180 or like conductive material to eliminate any air gaps between the temperature sensor element 200 and the center section162 of the plate 160 to maximize heat transfer between the pipe 20, the plate 160, and the temperature sensor element 200. The center section162 of the plate 160 in contact with the pipe 20 may also be coated with a thermally-conductive compound to maximize the heat transfer between the pipe 20 and the plate 160.

With reference again to FIGS. 7A and 7B, the portions of the wings 164 extending laterally from the bend in the wing 164 engage portions of the bottom wall 156 surrounding the hole 159 in the cup 150. More specifically, a bottom surface of the portion of the wing 164 extending laterally from the bend in the wing 164 contacts an upper surface of the bottom wall 156 of the cup 150 surrounding the hole 159. Bottom portions of the side walls 136 on the connector body also contact the wings 164, that is, the upper surface of the portion of the wings extending laterally from the bend, to sandwich and/or press the portion of the wings 164 extending laterally from the bend of the wing 164 between the bottom wall 156 and the distal ends of the side walls 136. That is, bottom surfaces of the wings 164 rest against the interior surface 156b of the bottom wall 156 of the cup when the center section162 of the plate 160 is positioned within the hole 159 on the bottom wall 156. When the connector body 130 is joined to the cup 150, the distal ends of the side walls 136 contact the upper surfaces of the wings 164 to fix the plate 160 in position relative to the cup 150. Fixing the plate 160 in place within the housing 170 using the side walls 136 of the connector body 130 and the bottom wall 156 of the cup 150 avoids having to use an epoxy or other adhesive to fix the plate 160 in position within the housing 170. The dimensional tolerances of the center section162 of the plate 160 and the hole 159 may be adjusted so that when the connector body 130 is joined to the cup 150 and the plate 160 is fixed in place, the center section162 of the plate 160 in the hole 159 forms a seal to limit and/or prevent the ingress of water, dust or other foreign matter from entering the housing 170.

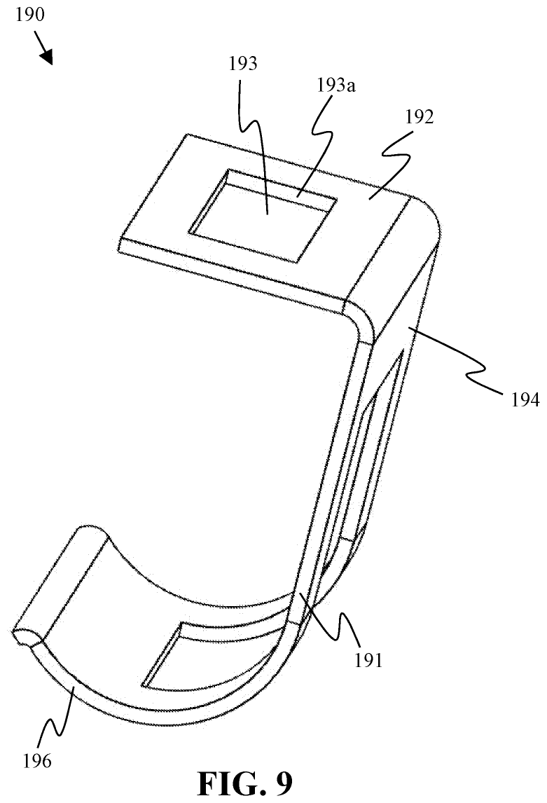

With reference now to FIG. 9, an example clip 190 is illustrated. The clip 190 may be a side mount-type clip 190. The clip 190 includes an upper engagement portion 192 with a hole 193, an intermediate portion 194, and a lower engagement portion 196.

The upper engagement portion 192 of the clip 190 has a hole 193 with dimensions slightly larger than the length and width dimensions of the upper projection 140 on the connector body 130. The conductive leads 142 projecting from the upper projection 140 of the connector body 130 pass through the hole 193 when the hole 193, or more specifically the walls 193a that bound and define the hole 193, are engaged to the upper projection 140 of the connector body 130. In such manner, the housing 170 of the temperature sensor assembly 10 can be attached to a pipe with the clip 190 with the conductive leads 142 left unhindered to connect to an external connection (not shown). The engagement of the upper projection 140 of the connector body 130 in the hole 193 allows the bottom surface of the upper engagement portion 192 to sit flush against the upper side 133 of the planar member 132 when the clip 190 is joined to the connector body 130.

The intermediate portion 194 of the clip 190 is used to connect the upper engagement portion 192 with the lower engagement portion 196. The intermediate portion 194 can include one or more legs 191 extending generally perpendicularly from the upper engagement portion 192 toward the lower engagement portion 196. The intermediate portion 194 of the clip 190 can also limit lateral movement of the sensor housing 170 on the pipe 20 when the sensor housing 170 is help in place by the clip 190.

The lower engagement portion 196 of the clip 190 extends from the intermediate portion 194 and is curved to match the rounded profile of the pipe 20. The lower engagement portion 196 may be flexible to allow the lower engagement portion 196 to wrap around and engage the pipe 20 when other portions of the clip 190 are engaged with, and positioned to secure, the housing 170 of the temperature sensor assembly 10 in place on the pipe 20. The intermediate portion 194 of the clip 190 may facilitate the ability for the lower engagement portion to be flexed so that the clip 190 can engage the pipe 20, e.g., with a “snap-fit.” Once in place, the intermediate portion 194 pulls the upper engagement portion 192 toward the lower engagement portion 196 and vice versa to bias the housing 170 of the temperature sensor assembly against the pipe 20.

The clip 190 may be a metal and formed by metal working processes such as stamping and bending. The clip 190 may also be of a thermoplastic material and formed by a process such as injection molding.

With respect to the adaptability and modularity of the connector body 130, the cup 150, the clip 190, and the temperature sensor element 200, various configurations may be realized while maintaining the modularity of parts within the temperature sensor assembly 10. For example, if the dimensions of the cup 150 are fixed so as accommodate a variety of different temperature sensor elements 200, certain dimensions of the connector body 130 and the clip 190 may also be fixed. That is, if a user needs or desires to change the connector body 130 to include a different type of connector, a user may select from different connector bodies 130 having the same size planar members 132 to be used with a standardized size cup 150 to easily interchange one connector body 130 having a certain connection type with another connector body 130 having a different connection type.

Likewise, if the length and width dimensions of the upper projection 140 of the of the connector body 130 are standardized to match standardized dimensions of the hole 193 in a clip (e.g., the clip 190), various types of clips may be used interchangeably to secure the sensor housing 170 of a temperature sensor assembly 10 to a pipe 20.

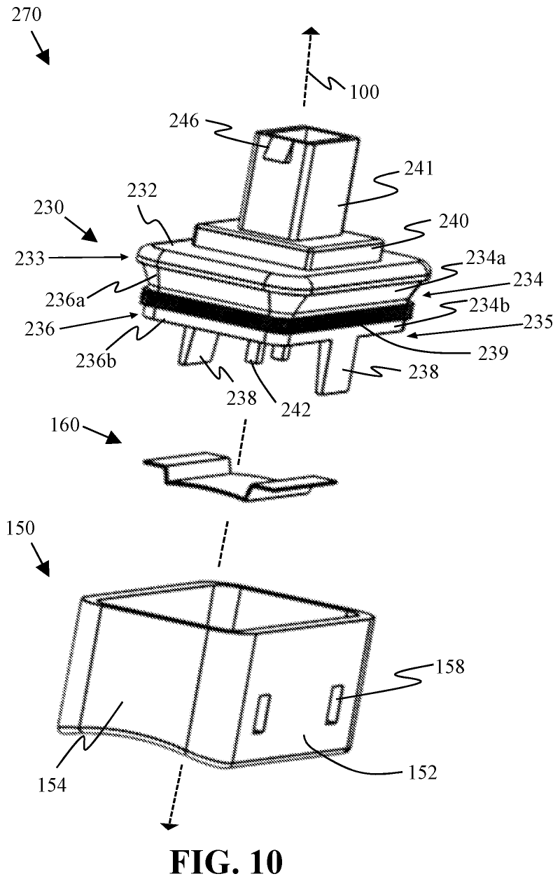

With reference now to FIG. 10, an alternative example embodiment of a sensor housing 270 of a temperature sensor assembly is illustrated. In the example sensor housing 270 shown in FIG. 10, the cup 150 and the plate 160 are the same as those illustrated and described in the previous embodiment. However, the connector body 230 is different than the connector body 130 described and illustrated in the previous example embodiment.

The connector body 230 illustrated in FIG. 10 includes a planar member 232 sized to fit the opening of the cup 150, but the connector body 230 does not have side walls with snap connections for engaging the notches 158 in the side walls 152 of the cup 150. Instead, the connector body 230 includes side walls 234 extending from the bottom side of the planar member 232 near the long edges of the planar member 132, and side walls 236 extending near the short edges of the planar member 132. The side walls 234, 236 include first portions 234a, 236a that are inclined slightly inwardly toward the vertical axis 100 and each other as the side walls 234, 236 extend away from the bottom of the planar member 132. Second portions 234b, 236b of the side walls 234, 236 extend from the first portions 234a, 236a, and generally perpendicularly to the planar member 232. In other words, as shown in FIG. 10, the connector member 230 includes a frustum-shaped projection 233 that extends from the bottom side of the planar member 232 with a cuboid-shaped projection 235 extending from the frustum-shaped projection 233 and disposed furthest from the planar member 232.

Tabs 238 extend from the second portions 234b of the side walls 234. The tabs 238 may abut the side sections of the thermally-conductive plate so as to fix the plate 160 in position at the bottom 152 of the cup 150 when the connector body 230 is joined to the cup 150.

In lieu of snap connections to engage the notches 158 on the cup 150 to connect the connector body 230 to the cup 150, the connector body 230 includes a seal 239 extending around the cuboid-shaped projection 235. The seal 239 may be of a flexible elastomeric material. For example, the seal 239 may be made of a rubber, silicone, elastic polymer, or like material. The seal 239 may include one or a plurality of projections or ribs. When the bottom of the connector body 230 is inserted into to the cup 150, the seal 239 (e.g., the ribs) may compress and/or deform in response to contacting the walls 152, 154 of the cup 150 to form a friction and/or interference fit between the seal 239 and the cup 150 to connect the connector body 230 to the cup 150 without the use of an adhesive.

The example connector body 230 in FIG. 10 also includes a connector shroud 241 extending from the upper projection 240 and surrounding the conductive leads 242. The connector shroud 241 covers the conductive leads 242 on the outside of the housing 270. The upper projection 240 may be dimensioned to a standardized length and width so as to fit a standardized size hole on an attachment clip, for example, the hole 193 of the clip 190 described in the previous embodiment. That is, the upper projection 240 can be used to engage a clip for attaching the housing 270 to a pipe. The connector shroud 241 may also include fasteners or barbs 246 that interface with an external connector (not shown) to secure the external connector to the connector shroud 241 when the external connector connects to the conductive leads 242.

The connector body 230 may be formed by injection molding, for example, by insert molding that molds the connector body 230 around the conductive leads 242 as an insert. However, the seal 239 may be added by an overmolding process. In this case, some features of the connector body 230 may be formed first by insert molding and injection molding processes and the seal 239 may be added subsequently by an overmolding process.

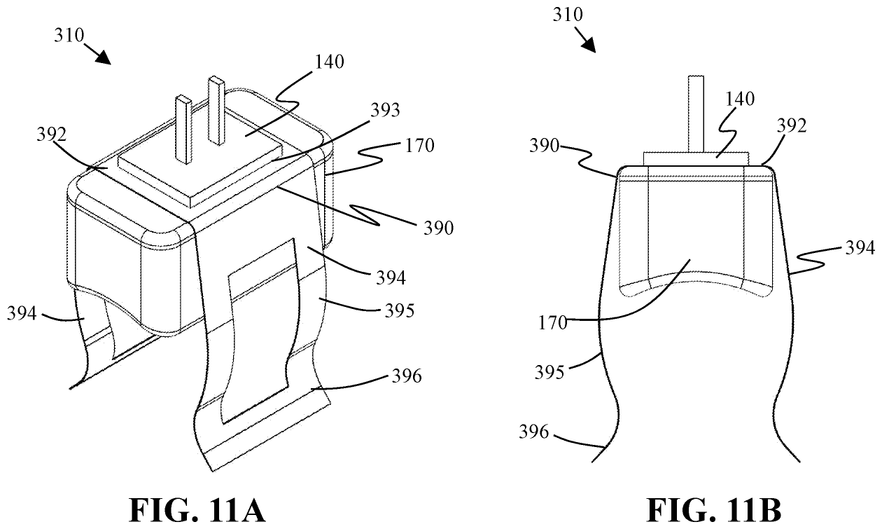

With reference now to FIGS. 11A and 11B, another example embodiment of a temperature sensor assembly 310 is illustrated. The temperature sensor assembly includes a housing 170 and a clip 390. While the housing 170 may be formed by the connector body, the cup, and the plate as illustrated and described in previous embodiments, the clip 390 can be a push mount-type clip.

The clip 390 includes a flat, planar top portion 392 with a hole 393 disposed centrally within the top portion 392. The clip 390 also includes two side portions 394 that extend from the top portion to cover the side walls of the housing 170. The side portions 394 of the clip 390 include a curved section 395 to match the curved profile of a pipe when the temperature sensor assembly 310 is installed on a pipe, and a bottom section 396 that curves in a direction opposite to, and away from, the curved section 395.

The hole 393 is dimensioned to the length and width of the upper projection 140 so that the upper projection 140 passes through the hole 393 when the clip 390 is installed on the housing 170. Once the hole 393 of the clip 390 engages the upper projection 140, the bottom side of the top portion 392 sits flush against the top surface of the housing 170.

The clip 390 may be of a flexible and/or plastically deformable material such as metal or plastic that allows the clip 390 to deform under stress and return to an original state when the stress acting on the clip 390 is removed. That is, the clip 390 is flexible enough so that portions of the clip 390 can flex to facilitate installation of the temperature sensor assembly 310 onto a pipe.

When the temperature sensor assembly 310 is attached to a pipe, the bottom section 396 of the clip 390 first contacts the pipe and the outward curving portion facilitates the spreading of the side portions 394 of the clip 390 around the pipe. Once the curved section 395 begins to contour to the profile of the pipe, the clip then returns from a spread position to more of a non-deformation state and the pipe is engaged by the curved section 395 to hold the temperature sensor assembly 310 in place on the pipe.

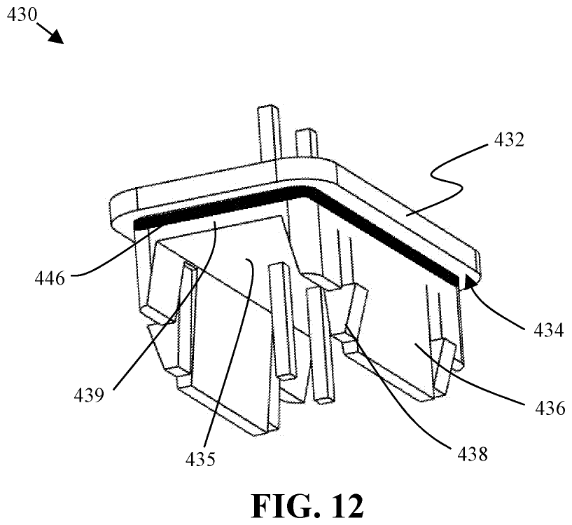

With reference now to FIG. 12, an example connector body 430 is illustrated. The example connector body 430 includes a seal 446 disposed on the lower projection 435 on the bottom side 434 of the planar member 432. The connector body 430 is similar to the connector body 130 described with respect to FIGS. 3A and 3B. However, the connector body 430 includes the seal 446. The seal 446 may be of a flexible elastomeric material and disposed around the side walls 436 and the short end surfaces 439, and adjacent to the planar member 432. The seal 446 may be made, for example, of a rubber, silicone, or elastic polymer that is added to the connector body 430 by an overmolding process.

When the connector body 430 is connected to a cup (e.g., the cup 150), the walls of the cup may press on the seal 446 to compress or deform the seal 446 when the lower projection 435 of the connector body 430 is inserted into the cup. In this manner, the seal 446 may serve to provide a press fit connection and a friction fit between the connector body 430 and the cup. The seal 446 may be used in addition to the snap connections 438 to join the connector body 430 to a cup. In this manner, the connector body 430 may be joined to a cup without the use of epoxy or other adhesives.

The seal 446 may also limit and/or prevent the ingress of dust, water or other foreign matter from entering the inner volume of the housing when the connector body 430 is joined to a cup.

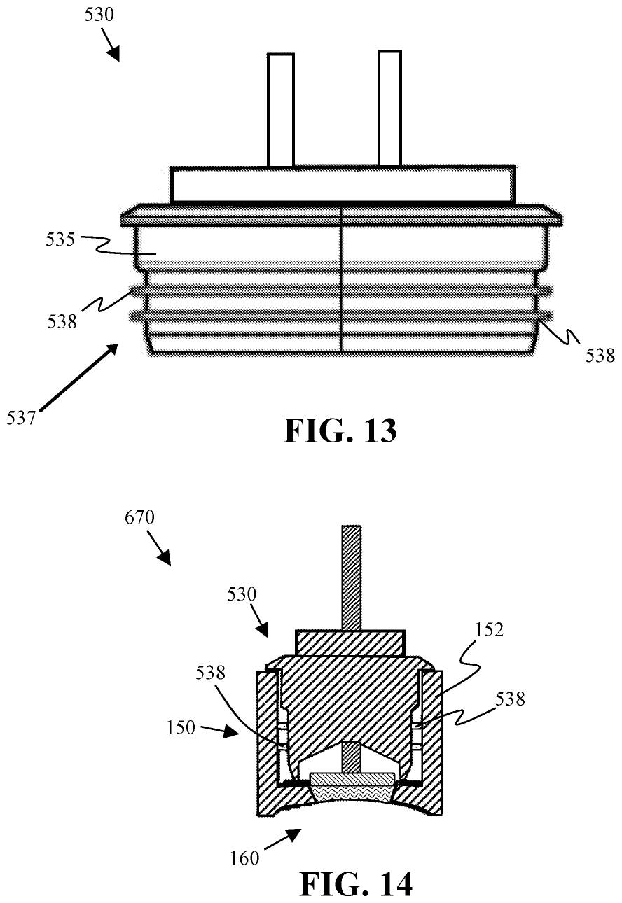

With reference now to FIG. 13, another example embodiment of a connector body 530 is shown. While the connector body 530 is similar to the connector bodies described in previous embodiments, the lower projection 535 of the connector body 530 can include a seal 537 comprising a plurality of projections or ribs 538 extending around the perimeter (e.g., the side edge surfaces) of the lower projection 535. The ribs 538 may be of an elastomeric material, for example rubber, and the ribs 538 may be incorporated into the connector body 530 by way of an overmolding process after other plastic/polymer features of the connector body 530 are molded.

With reference now to FIG. 14, a cross-sectional view of another example embodiment of a housing 670 is shown. The example housing 670 includes the inner body (e.g., connector body 530) shown in FIG. 13 along with the outer body (e.g., the cup 150) and the thermally-conductive plate 160. When the connector body 530 is inserted into the cup 150, the ribs 538 may deform and/or engage the side walls 152, 154 of the cup to provide a friction/interference fit between the connector body 530 and the cup 150. In this way, the connector body 530 can be sealingly secured to the cup 150 without the use of epoxy or other adhesives.

With respect to the all of the different embodiments described above, the connector body and cup may be formed by manufacturing processes such as injection molding. The metal conductive leads in the connector body may be used as an insert for an insert injection molding process whereby the plastic portions of the connector body are injection molded around the metal conductive leads. Likewise, the metal plate in the cup can either be placed by machine when assembling a temperature sensor assembly or the metal plate could be used as an insert in an insert injection molding process to form the plastic portions of the cup around the metal plate. Subsequent processes may be used to add overmolded features such as seals and ribs. Further manufacturing processes may include attaching a temperature sensor to a connector body by a joining process such as soldering. Further manufacturing processes may also include adding the plate to the cup and coating the bottom of the plate with a thermal compound so that the plate/cup combination with thermal compound appears as one unit. Such subassembly and finishing of parts may further ease the automated assembly of a temperature sensor assembly.

As described above, certain features of the connector body, the cup, the plate, and the clip may be standardized to provide interchangeability between different types of connector bodies and clips when assembling a temperature sensor assembly. In other words, the parts of the temperature sensor assembly may be modular. For example, a customer may select the temperature sensor attached to the connector body, the attachment type for attaching the connector body to the cup, and the connector type for attaching an external connector to the conductive leads on the connector body based on a specific application of the customer. Likewise, the customer may select from among a variety of different clips for attaching the housing of the temperature sensor assembly to a pipe depending on the application of the customer. By standardization, a customer may not only be able to choose from a variety of options when manufacturing a temperature sensor assembly, but the manufacturing process may be simplified by automating the assembly process.

All of the connector bodies, cups, plates, and clips described herein can be manufactured as pick and place components. That is, the connector bodies, cups, plates, and clips can be used interchangeably in automated assembly processes to assemble customer-specific temperature sensor assemblies. For example, a multi-axis industrial robot may be able to choose (i.e., pick) from among a variety of connector bodies having different connector portions and temperature sensors to connect to standardized plates and cups (e.g., by placing) to form a sensor housing specific to the applications of a customer. A multi-axis industrial robot can then select (i.e., pick) from among a variety of different clips to add to the housing to complete the customer-specific temperature sensor assembly. Moreover, the assembly of the temperature sensor assemblies described herein may be further simplified by eliminating the use of adhesives to assemble the connector body, cup, plate, and clip together to form a temperature sensor assembly. This not only saves on cost and manufacturing time, but also reduces the mass of the temperature sensor assembly.

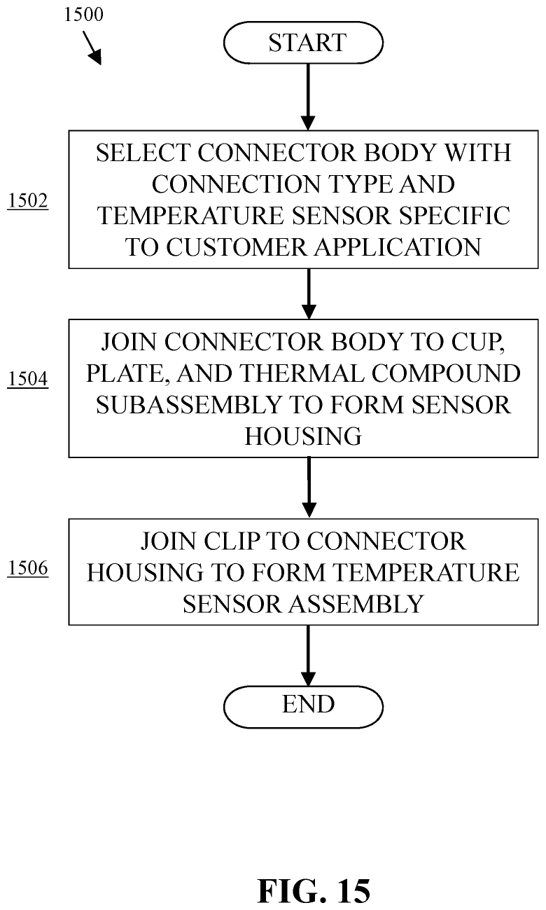

With reference now to FIG. 15, an example assembly process 1500 of a temperature sensor assembly is illustrated. The cup 150, the plate 160, and the thermal compound 180 may be selected as one unit (i.e., one subassembly) during the assembly process 1500. In other examples, however, processing may include placing the plate 160 within the cup 150 and adding a thermal compound 180 to the plate 160 as separate assembly processes. At 1502, a connector body and temperature sensor assembly are selected from among a variety of different connector bodies/temperature sensor assemblies. At 1504, the connector body is joined to the cup, plate, and thermal compound subassembly to form the sensor housing. At 1506, a clip is added to the sensor housing to complete the assembly of a temperature sensor assembly.

The example assembly process 1500 may be performed by one or more multi-axis pick and place robots (e.g., multi-axis robotic arms). In this manner, the assembly process 1500 and variations of the assembly process 1500 may be described in terms of “picking” and “placing” to describe the actions of the one or more multi-axis pick and place robot during assembly.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. A temperature sensor assembly comprising:
an inner body comprising a planar member and a lower projection extending from a bottom side of the planar member, the planar member comprising an upper projection extending from a top side of the planar member;
a plurality of electrically conductive leads extending through the inner body and generally parallel to an axis of the temperature sensor assembly;
a temperature sensor element comprising a temperature-sensitive resistor electrically connected to the plurality of electrically conductive leads;
an outer body comprising a bottom wall having a centrally disposed opening;
a thermally-conductive plate located within the outer body, wherein a portion of the thermally-conductive plate is positioned in the opening of the bottom wall of the outer body;
wherein the inner body is received in the outer body and the temperature sensor element is disposed near to the thermally-conductive plate; and
a fastener clip attached to the upper projection of the inner body and extending beneath the bottom wall of the outer body.

2. The temperature sensor assembly of claim 1, wherein the lower projection of the inner body comprises two opposing long edges, two opposing short edges and two opposing walls;
wherein each of the two opposing walls extends from a proximal end near a respective one of the two opposing long edges of the lower projection to a distal end;
wherein the distal ends of the two opposing walls abut the thermally-conductive plate.

3. The temperature sensor assembly of claim 2, wherein the thermally-conductive plate includes a center section and two side sections;
wherein each of the two side sections comprises a first portion that extends from the center section at an angle relative to the center section and a second portion that extends from the first portion in a direction generally parallel to the center section;
wherein the center section of the thermally-conductive plate is disposed within the opening in the bottom wall of the outer body, and;
wherein the second portions of the two side sections engage an inner side of the bottom wall of the outer body;
wherein the distal ends of the two opposing walls of the lower projection abut a respective side section of the thermally-conductive plate; and
wherein the temperature sensor element is positioned adjacent to the center section of the thermally-conductive plate and within the outer body.

4. The temperature sensor assembly of claim 3, wherein the planar member of the inner body comprises two opposing long edges and two opposing short edges;
wherein the two opposing short edges of the lower projection are, respectively, offset from the two opposing short edges of the planar member along the axis;
wherein the two opposing walls of the lower projection are, respectively, offset from the two opposing long edges of the planar member toward the axis; and
wherein each of the two opposing walls of the lower projection includes a hook-like projection extending from a respective opposing wall away from the axis.
wherein the bottom wall of the outer body has two opposing long edges and two opposing short edges;
wherein the outer body further comprises two opposing long sidewalls and two opposing short side walls, each of the two opposing long side walls of the outer body extending from a respective opposing long edge of the bottom wall of the outer body and each of the two opposing short side walls of the outer body extending from a respective opposing short edge of the bottom wall of the outer body;
wherein each of the two opposing long side walls of the outer body includes a notch; and
wherein the hook-like projections on the two opposing walls of the lower projection of the inner body respectively engage the notches of the two opposing long side walls of the outer body to attach the inner body to the outer body.

5. The temperature sensor assembly of claim 4, wherein
the bottom wall of the outer body comprises a concave surface.

6. The temperature sensor assembly of claim 4, wherein the fastener clip includes an upper engagement portion comprising an opening therethrough; and
wherein the upper projection of the inner body engages the opening of the fastener clip to attach the fastener clip to the inner body.

7. The temperature sensor assembly of claim 4, wherein the temperature sensor element is one of a negative temperature coefficient thermistor, a positive temperature coefficient thermistor and a platinum resistance thermometer.

8. The temperature sensor assembly of claim 1, wherein the upper projection comprises a shroud extending from the upper projection that surrounds the plurality of electrically conductive leads;
wherein the shroud includes at least one fastener configured to attach an external connector to the shroud when the external connector is electrically connected to the plurality of electrically conductive leads.

9. The temperature sensor assembly of claim 1, further comprising a thermal compound disposed between the temperature sensor element and the bottom of the plate within the outer body.

10. The temperature sensor assembly of claim 1, further comprising an elastomeric seal that wraps around a perimeter of the inner body.

11. The temperature sensor assembly of claim 10 wherein the seal creates an interference fit between the inner body and the outer body.

12. The temperature sensor assembly of claim 11, wherein the seal is located at the bottom side of the planar member of the inner body.

13. The temperature sensor assembly of claim 11, wherein inner body comprises at least one tab extending generally parallel to the axis;
wherein the at least one tab contacts the thermally-conductive plate; and
wherein the seal comprises at least one deformable rib.

14. A temperature sensor assembly comprising:
an inner body including a planar member having a top side and a bottom side, a lower projection extending from the bottom side, an upper projection extending from the top side and a plurality of electrically conductive leads extending through the inner body;
a thermally-conductive plate;
an outer body comprising a bottom wall having a opening disposed centrally within the bottom wall, wherein the thermally-conductive plate is disposed within the outer body and a portion of the thermally-conductive plate is positioned within the opening of the bottom wall of the outer body;
an elastomeric seal extending around a perimeter of the lower projection of the inner body;
a fastener clip attached to the inner body and comprising an upper engagement portion that extends generally parallel to the top side of the inner body and comprises an opening therethrough, and wherein the upper projection of the inner body engages the opening in the upper engagement portion of the fastener clip to attach the fastener clip to the inner body;
a temperature sensor element comprising a temperature-sensitive resistor electrically connected to the plurality of electrically conductive leads; and
wherein the inner body is received within the outer body. the temperature sensor element is located near the thermally-conductive plate and the seal is located between the inner body and the outer body.

15. The temperature sensor assembly of claim 14, further comprising a thermal compound disposed within the outer body and between the temperature sensor element and the thermally-conductive plate.

16. The temperature sensor assembly of claim 14, wherein the seal is elastomeric and that provides an interference fit between the inner body and the outer body.

17. The temperature sensor assembly of claim 14 wherein the seal is located at the bottom side of the planar member of the inner body.

18. The temperature sensor assembly of claim 14. wherein the upper engagement portion of the fastener clip further comprises a planar-shaped top portion and two leg portions, wherein the top portion extends generally parallel to the top side of the planar member of the inner body and each of the two side portions extends from a respective side of the top portion and comprise a curved surface.

19. A temperature sensor assembly comprising:
a connector body comprising a generally longitudinally-extending first axis, a second axis that is generally perpendicular to the first axis, a generally rectangular planar member having a top side and a bottom side and being oriented generally parallel to the first axis and a lower projection extending from the planar member generally parallel to the second axis:
wherein the lower projection includes two opposing first side walls, two opposing second side walls, two first edges and two second edges, wherein each of the first side walls and each of the second side walls comprise a proximal portion and a distal portion, wherein the proximal portions form a frustum shape and the distal portions form a cuboid shape;
a seal extending about a perimeter of the connector body;
a plurality of electrically conductive leads extending through the connector body oriented generally parallel to the first axis;
a temperature sensor element comprising a temperature-sensitive resistor electrically connected to the plurality of electrically conductive leads and attached to the connector body,
a thermally-conductive plate;
a cup comprising an arcuate bottom wall having a hole centrally disposed within the bottom wall;
a clip attached to the connector body; and
wherein the thermally-conductive plate is disposed within the cup and a central portion of the thermally-conductive plate is located in the hole of the bottom wall of the cup; and
wherein the connector body is attached to the cup so that the temperature sensor element is disposed within the cup near the plate.

20. The temperature sensor assembly of claim 19, wherein each of the two first side walls includes a tab extending from the distal portion of a respective first side wall; and
wherein each tab contacts the thermally-conductive plate.

21. The temperature sensor assembly of claim 19, wherein the seal comprises a plurality of ribs and extends around the distal portions of the first side walls and the second side walls.
